(19) United States
(12) Patent Application Publication
(10) Pub. No.: US 2024/0268600 A1
(43) Pub. Date: Aug. 15, 2024

(54) A lid for a pan or vessel to direct cooking smoke and odor into a kitchen exhaust system.

(71) Applicant: Richard Lee Bognar, Milton, GA (US)

(72) Inventor: Richard Lee Bognar, Milton, GA (US)

(21) Appl. No.: 18/166,633

(22) Filed: Feb. 9, 2023

(51) Int. Cl. A47J 36/06

(52) U.S. Cl. CPC A47J 36/064

(57) ABSTRACT

A lid for use with a frying pan, or any pan. The lid has multiple embodiments, such as, directing cooking smoke and odor into under-performing range hoods and downdraft systems. Purchasing new exhaust systems are expensive with little or no guarantees from any manufacturer that their system will remove all cooking smoke. The current invention may be purchased at a fraction of the cost, and will also guarantee total smoke exhaustion. The current invention directs all harmful chemicals emitted from inside a pan, and from stovetop burners, into an exhaust system so they are removed from the home. The invention protects humans and animals from breathing harmful chemicals into their lungs. It protects against kitchen fires, regulates the cooking temperature inside the pan, and allows self-basting of food. The current invention is made from FDA food grade approved material, and is dishwater safe.

### FIELD OF INVENTION

The present invention pertains to the field of cookware and particularly to a lid placed on a pan offering multiple features and health benefits.

### DESCRIPTION OF TECHNICAL PROBLEM

The current invention addresses various indoor cooking smoke and harmful chemical problems. Millions of homes, commercial, industrial, and other facilities where food is prepared, have inadequate cooking smoke exhaust systems. Replacing an exhaust system can be an expensive proposition, and for reasons discussed in [0004], there are few, if any, manufacturer guarantees that purchasing their new exhaust systems, that it will perform better at removing cooking smoke than the homeowner's existing system.

Research shows that individuals, such as adult females, homemakers, and restaurant chefs, and other individuals that spend a great deal of time cooking in kitchens, are more susceptible to contracting cooking smoke related illnesses, such as, respiratory irritation, pulmonary disease, and cardio-vascular disease. Research also shows that young children growing up in homes with poor indoor air quality are more likely to develop asthma, allergies, or pulmonary illnesses. A young child's immune system does not fully develop until the age of seven or eight, and in the U.S., six million children have contracted asthma prior to their sixth year of age. Cooking smoke has a deleterious effect on those with chronic diseases, such as high blood pressure, diabetes, and cardio vascular-disease, to name a few. As these individuals grow older, indoor cooking smoke may worsen their chronic condition. On our planet, four million people die each year from breathing the air inside their home, mostly in third world nations where they have extremely poor exhaust systems, or no exhaust system at all. Another ten million people, once again, mostly in third world nations, develop any number of pulmonary diseases each year. Human lungs are the most sensitive organ in our body when it comes to the environment. This is clearly exemplified is the U.S., where twenty-six million people have asthma, fifty million people suffer with allergies, and another sixteen million have contracted COPD. This is a total of ninety-one million chronic illnesses, without counting tuberculosis, emphysema, and many other respiratory diseases. Very little research has been conducted to determine the amount of illness contracted from cooking smoke, fumes, and harmful chemicals, but as indoor air-quality research continues, the percentage of illness caused by these indoor illnesses has increased.

Cooking indoors on a cooktop using a pot or pan, more specifically a frying pan when cooking meat and fish, is typically done without the use of a frying pan lid. Cooking oil and fat from meat, when cooked at high temperatures, creates a great deal of smoke in the kitchen, and the use of an exhaust system is required. One embodiment of the current invention addresses the failure of many range hoods and downdraft system to exhaust all cooking smoke emitted from the frying pan, or other types of pans. Here are several reasons why this range hood problem exists: (1) The depth of many range hoods extending outward from the wall are less than the depth of stovetops (cooktops) extending out from the wall, and these range hoods are incapable of capturing all cooking smoke, especially the smoke emitted from pans on the front burner of a stovetop. (2) The range hood is old and the enclosed motor performs at a reduced capacity. (3) Regulations in the U.S. are lax compared to regulations in many countries, and some manufacturers in the U.S. produce lower performing products. (4) In the U.S., building code requirements for range hoods fall under the auspices of municipalities and counties, where strong regulations have not been adopted, allowing builders to install less expensive and limited performing exhaust equipment.

The current invention addresses the problem of kitchen fires, and provides a solution to prevent it from occurring.

The current invention addresses the problem of the release of harmful cooking chemicals, such as, volatile organic compounds, and fine particulate matter.

The current invention addresses the problem of poor indoor-air-quality caused by cooking smoke, fumes, harmful chemicals, and their byproducts.

### RELATED ART

The opportunity to remedy cooking smoke problems has given rise to new technology and devices designed to augment under-performing range hoods and downdraft exhaust systems without the need to replace the current systems. Described below are previous inventions, and only in the most general sense do they relate to the current invention. Nonetheless, their art does offer a device to resolve the cooking smoke problem.

Related art U.S. Pat. No. 9,848,734 B2 and U.S. 2008/0203095 A1 are lids with a protruding vertical exhaust pipe for the purpose of directing cooking smoke from the pan and into an overhead range hood.

Related art U.S. 2009/0261110 A1 is a lid to reduce kitchen fires and keep the cooking area clean. This invention also embodies a hinged door for reaching inside the pan to turn cooking food over to its other side.

Related art U.S. Pat. No. 9,492,030 B2 is a pan and lid combination to resolve the cooking smoke and odor problem. With this invention smoke is forced into a tube located in the center of the frying pan, where it is directed downward and out through the bottom of the pan and into the gas burner flame, the location where smoke and odor are burned and destroyed as the means of removing it from the home.

### PRESENT INVENTION COMPARISON TO PRIOR ART

The current invention differs in many respects from the above-mentioned art.

Related art U.S. Pat. No. 9,848,734 B2 and U.S. 2008/0203095 A1 is art that has a protruding vertical exhaust pipe, and directs cooking smoke, heated moisture, and heated oils upward into an overhead range hood. The current invention, though, separates the direction cooking smoke is forced to move, which is in a horizontal direction as it exits the pan, from the direction moisture and cooking oil is allowed to move inside the pan, which is in a vertical direction. In addition, one purpose of the current invention is to retain as much moisture and cooking oil inside the pan as possible in order for self-basting to occur. The functionality of self-basting is fully described in the Detailed Description of the Invention. However, with regard to prior art, neither the stiff upward-only facing pipe, nor any feature or design within the embodiment of the pan lid, allow either art to separate cooking smoke from moisture and cooking oil while inside the pan.

Another embodiment of the current invention allows cooking smoke to be exhausted into both range hoods and downdraft systems. Prior inventions mentioned herein, allow cooking smoke, through use of a vertical facing pipe, to be exhaust into an overhead range hood only, and neither invention, nor any embodiment of the invention, features or designs, claims or shows capacity to direct cooking smoke into a downdraft exhaust system.

Another embodiment of the current invention directs all harmful chemicals, which include particulate matter and volatile organic matter, and their byproducts, into both range hoods and downdraft exhaust systems. The current invention prevents these chemicals from being released into the indoor home atmosphere, and humans and animals (pets) are protected from breathing these chemicals into their lungs. Neither invention referred to herein has claimed, nor does the embodiment of their inventions possess any designs or features, or show the capacity to exhaust any harmful chemical, including particulate matter and volatile organic compounds.

Additional embodiments of the current invention are listed in this paragraph and will be fully explained in the Detailed Description of the Invention. The below listed embodiments are not claimed, nor is capacity shown in any prior art to offer these embodiments: (1) temperature regulation inside the frying pan to allow perfect food searing. (2) self-basting embodiment to allow food to remain moist and tender on the inside throughout the cooking process. (3) improved quality of indoor air and odor reduction. (4) kitchen fire protection, (5) fire injury and death reduction (6) reduced cooking energy cost. (7) cooking smoke separation from moisture and cooking oil. (8) exhaustion of cooking smoke into both range hoods and downdraft systems.

Related art U.S. 2009/0261110 A1 operates with a hinged door on its lid, which has perforations in the door to allow steam and smoke to escape while food is being cooked. The main purpose of this art may not be the total exhaustion of cooking smoke, but rather, to offer the convenience of easily turning over food during the cooking process. Perforations in the door and, opening the door, allows cooking smoke to escape, and potentially, to drift vertically, and in multiple directions. This allows cooking smoke to land on cabinets, countertops, appliances, and other kitchen furniture, where this smoke coats furniture and turns into flammable grease. Therefore, this art does not appear to support their claim of fire prevention, since the number one cause of kitchen fires in the U.S. is the build-up of flammable grease on kitchen hardware that accidently ignites.

The current invention directs all cooking smoke into an area outside the edge of the pan where it is captured and exhausted by a range hood or downdraft system. This prevents aimless drifting of cooking smoke to land on and coat kitchen furniture with flammable grease. Therefore, current invention substantially reduces, and in many homes, may eliminate accidental ignition of flammable grease, that is the cause of most kitchen fires.

Additional embodiments of the current invention are listed in this paragraph and will be fully explained in the Detailed Description of the Invention. The below listed embodiments are not claimed, nor is capacity shown in any prior art to offer these embodiments: (1) temperature regulation inside the frying pan to allow perfect food searing. (2) self-basting embodiment to allow food to remain moist and tender on the inside throughout the cooking process. (3) improved quality of indoor air and odor reduction. (4) kitchen fire protection. (5) fire injury and death reduction (6) reduced cooking energy cost. (7) cooking smoke separation from moisture and cooking oil. (8) exhaustion of cooking smoke into both range hoods and downdraft systems.

Related art U.S. Pat. No. 9,492,030 B2 requires a pan and lid combination to resolve the cooking smoke and odor problem. This art works only with gas stovetops and not with electric stovetops. Claimed by this art is the destruction of cooking smoke and odor once it is forced to exit through the bottom of the pan and into the gas flame. Not discussed are the unexhausted burnt substances, such as particulate matter and volatile organic compounds, that are released into the indoor atmosphere, and that places humans and animals living inside the home at risk of breathing these harmful chemicals into their lungs.

The current invention resolves the indoor particulate matter and volatile organic compound problem, and protects humans and animals from breathing these chemicals into their lungs. These harmful chemicals, along with their byproducts, are directed into a range hood or downdraft exhaust system. The detailed description of how these toxins are removed from the home is presented in the Detailed Description of the Invention.

Additional embodiments of the current invention listed in this paragraph will be fully explained in the Detailed Description of the Invention. Furthermore, the below listed embodiments have not been claimed, nor is capacity shown to exist in any prior art offered: (1) temperature regulation inside the frying pan to allow perfect food searing. (2) self-basting feature so food remains moist and tender on the inside throughout the cooking process. (3) improved quality of indoor air and odor reduction. (4) kitchen fire protection. (5) fire injury and death reduction (6) reduced cooking energy cost. (7) cooking smoke separation from moisture and cooking oil. (8) exhaustion of cooking smoke into both range hoods and downdraft systems.

### BRIEF DESCRIPTION OF INVENTION

The disclosure provides a lid for use with a cooking vessel, such as a frying pan, or with the use on any pan type. The lid design offers multiple embodiments, features, and health benefits, such as directing cooking smoke, steam, vapor, odor, and grease into working range hoods, and more importantly, into under-performing range hoods and downdraft systems. Prior to the current invention, many of these exhaust systems have failed to capture and exhaust all cooking smoke, as well as, harmful chemicals emitted from inside a pan and from stovetop burners. The current invention protects humans and animals from breathing harmful chemicals, such as, volatile organic compounds, and particulate matter, into their lungs. These carcinogens have been shown to cause pulmonary disease, cardio-vascular disease, and cancer. The current invention improves indoor quality-of-air by removing harmful chemicals, cooking smoke, grease, and odor, from the home. Two additional embodiments improve the cooking experience. The first is temperature regulation, where fresh air is pulled into the pan through a small rear opening, which allows food to perfectly sear on its surface. The second embodiment is self-basting, where moisture and cooking oil splatters upward onto the lid underside and drips down on the food. These embodiments allow food to sear on its outside and remain moist on the inside. Another two embodiments address the prevention of kitchen fires. The first embodiment blocks cooking oil fires inside the pan, as the result of, covering the pan with a lid to prevent a flash oil fire from occurring. The second embodiment restricts cooking smoke and flammable grease from coating cabinets, countertops, appliances, and other furniture, and in so doing, prevents the number one cause of kitchen fires in the U.S., which is the accidental ignition of grease that causes thousands of injuries and hundreds of deaths each year.

There has thus been briefly outlined, rather broadly, the more important features of the current invention in order that the detailed description thereof that follows may be better understood, and in order that the present contribution to the art may be better appreciated. There are additional benefits of the current invention that will be described thereinafter and which will contribute to the subject matter of the claims appended hereto.

With respect to the above statement, and before explaining the number of embodiments of the invention and claims in detail, let it be known that the invention is not limited to its application to the details of construction, and to the arrangement of its components set forth in the following description, or illustrated in the drawings, The invention is capable of other embodiments and of being practiced and carried out in various ways. The broad descriptions employed herein are to clearly explain to anyone without technical or legal experience, so they can understand and gain full appreciation of the current invention.

Those skilled in the art will appreciate that the conception, upon which this disclosure is based, may readily be utilized as a basis for the designing of other structures, methods, and systems for carrying out the several purposes of the present invention. It is important therefore, that the claims be regarded as including such equivalent construction insofar as they do not depart from the spirit and scope of the present invention.

### BRIEF DESCRIPTION OF DRAWINGS

FIG. 1 side view of lid:
a. front lid protrusion exceeds pan edge with opening for smoke to exit pan
b. rear lid cutaway where fresh air enters pan
c. tabs to secure lid firmly on top of pan
d. edge of lid rests on pan to seal perimeter of pan except for front and rear opening

FIG. 2 underside of lid:
a. front lip (in conjunction with rear lip) regulates temperature and moisture inside pan
b. rear lip (in conjunction with front lip) regulates temperature and moisture inside pan

FIG. 3 lid directing cooking smoke into range hood exhaust system

FIG. 4 side view of lid:
a. lid directing cooking smoke into downdraft exhaust system
b. perimeter lip to capture and exhaust particulate matter emitted from burner

### DETAILED DESCRIPTION OF INVENTION

The current invention is a lid (FIG. 1) placed on a pan (pan shall refer to any pot or vessel) directing cooking smoke, fumes, and chemicals emitted from inside a pan, and fumes and chemicals emitted from gas or electric stovetop burners, into an area past the front edge of the lid where an overhead range hood or downdraft system captures and exhausts cooking smoke, fumes, and chemicals from the home. The embodiment of the lid may be constructed of one piece of material made from, stainless steel, glass, silicone, or any food grade approved material. Another embodiment of the lid may have moving parts or attachments, such as: a removable handle, or a hinged door allowed to open, close, and to seal tightly on top of a pan while cooking certain foods. The current invention may be used with both under-performing and perfectly performing exhaust systems, in order to utilize other embodiments besides cooking smoke removal, such as, fire protection, harmful chemical removal, self-basting, and as a splatter-guard.

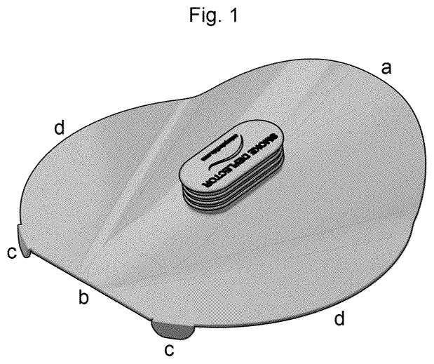

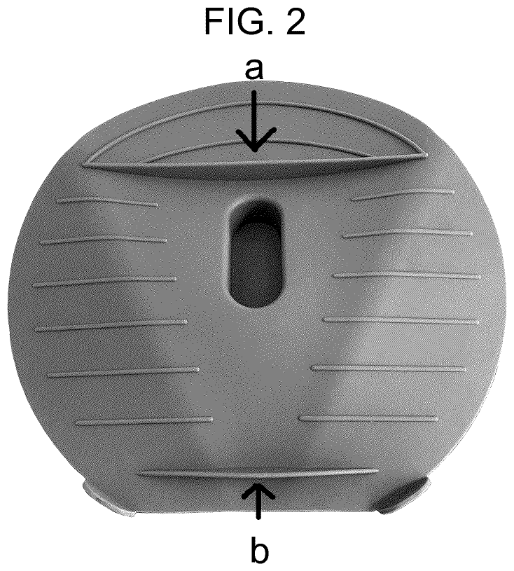

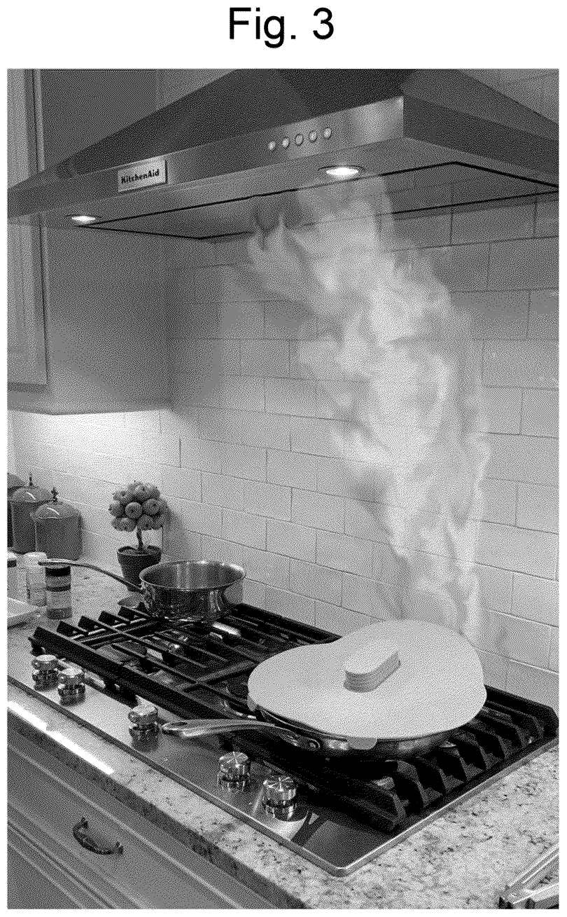

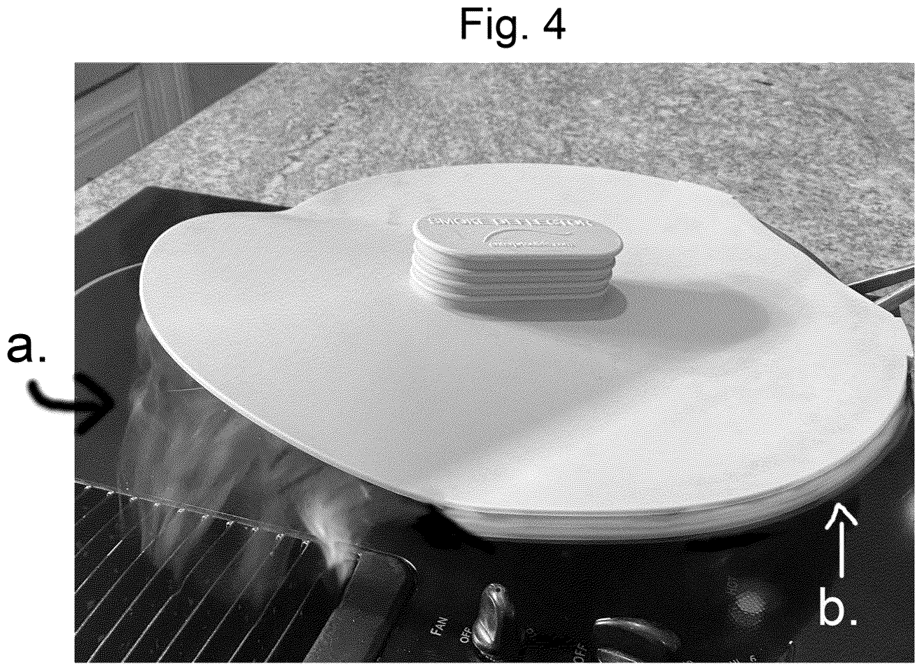

To use the lid for the purpose of removing cooking smoke and other harmful matter, where a range hood is installed over a stovetop, point the opening, the front of the lid (the highest inclined point on the lid) toward the back of the stovetop, and the upward contour of the lid forces cooking smoke inside the pan to follow the contour and move in a horizontal direction until it exits out the frontside of the pan and is guided into an area where, once it starts to drift upward, it will be captured by the exhaust system and removed from the home. (FIG. 3) It is important to state here, for reasons of a claim that will be made, that smoke, of its own volition, without any obstruction or device controlling its direction, will move in a vertical direction. And portions of smoke typically will drift into adjoining rooms. A detailed explanation of the importance of forcing cooking smoke to move in a horizontal direction is described in [0043].

To use the lid with downdraft exhaust systems, that are built into stovetops, point the front of the lid toward the downdraft exhaust, typically located in the center or rear of the stovetop. In either case, the lid will direct all cooking smoke emitted from the pan to an area where the downdraft system captures the smoke and exhausts it from the home. (FIG. 4).

The current invention solves the cooking smoke problem created by under-performing exhaust systems, which include but are not limited to: systems that are old with diminished motor functionality, those poorly designed or are inappropriate for use in a particular kitchen, and any range hood that fails to capture all cooking smoke. The system must, at a minimum, have some capacity to capture and draw cooking smoke, fumes, or chemicals directed to it by the lid, and with that ability, the current invention will serve as the perfect adjunct component, and the replacement of the in-place range hood or downdraft exhaust system will not be required.

The current invention solves the problem of volatile organic compounds (VOCs) that originate inside a pan from heated meat fat, and from the use of cooking oil that has reached its smoke point. These fats and oils release acrolein, formaldehyde, and other harmful chemicals into the kitchen atmosphere. These chemicals are carcinogens and when humans and animals breathe them into their lungs, they may cause respiratory irritation, headaches, nausea, and fatigue. More seriously, these chemicals are known to impair the body's ability to repair damaged DNA, and may lead to a range of diseases, such as: pulmonary disease, cardio-vascular disease, and cancer, to name only a few. The current invention protects humans and animals by directing VOCs, that originate inside the pan, to a place outside the pan, and where the exhaust system removes them before they are released into the indoor atmosphere (FIGS. 3 and 4a).

The current invention solves the problem of fine particulate matter (PM) that originate from gas flame stovetops, and to a lesser extent, from electric stovetops. PM are small particles of matter, and those with a diameter of 10 microns or less (PM10) are inhalable into the lungs and can induce adverse health effects. One byproduct of PM, known to be released into the indoor atmosphere is nitrogen dioxide, which has capacity to cause respiratory irritation, headaches, nausea, and fatigue. Research shows that children breathing this toxin, and others, into their lungs may develop asthma. Nitrogen dioxide has also shown the capacity to increase dementia in adults at an earlier age.

Since PM originates in the gas burner of stovetops, and in some electric burners on stovetops, a different embodiment for removing PM is required. This embodiment directs PM, and its byproducts, into the exhaust systems by means of extending the diameter of the lid, past the outside perimeter of the cooking pan. The extended portion of the lid may be embodied with an upward concavity, which is a hollowed-out channel, or track, on the underside of the lid that surrounds the outside perimeter of the pan for the purpose of capturing burner fumes that contain PM, and its byproducts, and other harmful chemicals, as they are emitted upward along the sides of the pan. With PM now captured by the lid, a second embodiment of the lid guides this harmful waste material to an area beyond the front perimeter of the lid where PM is now captured by the exhaust system and removed from the home. For the lid to guide PM to an area where the exhaust system captures it, a slight incline on the perimeter of the lid is created. It starts at the rear of the lid, the lowest point of the incline, and gradually reaches a point near the front of the lid, the highest point of the incline. Therefore, the upward contour of the lid serves as a guide to deliver all PM, and other harmful material, held inside the concavity, channel, or track, to a location near the front of the lid, where all harmful material is emitted into an area beyond the front edge of the lid, and captured by a range hood or downdraft system and removed from the home (FIGS. 3 and 4). This embodiment of the current invention prevents PM and other harmful chemical material from escaping into the indoor home atmosphere, and protects humans and animals from breathing these chemicals into their lungs.

Another embodiment of the current invention to remove PM and its byproducts emitted from gas and electric burners is to form a ninety-degree angled edge (FIG. 4b) around the perimeter of the lid for the capture of harmful matter as it rises from the stovetop burner. The degree of this angle may be greater or less than ninety-degrees, or even embodied with a rounded contour edge along the outside perimeter of the lid. The edge may incline exactly, or in similar construction to the embodiment described in the original current invention, which is an incline starting from the lowest point at the rear of the lid, where the incline continues until it reaches the highest point, near the front of the lid.

In another embodiment the lid may not incline at all. It will rest flat on the pan, and the perimeter of the lid, for clarification, will be parallel to the stovetop. PM and its byproducts are captured by the lid and drawn forward to the front of the lid by the suction, or pull, created by the exhaust system. In this embodiment, the lid extends beyond the circumference of the pan, and a concavity may exist, a ninety-degree formation may exist on the edge of the lid, where the edge formation may be greater of less than ninety degrees, or the extended lid may have a rounded edge. All embodiments described herein, capture, move, and guide, harmful material emitted from a gas or electric burner, to an area past the front edge of the lid, allowing harmful material to be captured and exhausted by a range hood or downdraft system. Furthermore, the embodiment prevents PM and other harmful material from being released into the home atmosphere, and protects humans and animals from breathing any of this harmful matter into their lungs.

The current invention solves the kitchen fire problem created by the build-up of grease on cabinets, countertops, appliances, and walls. Under-performing range hoods and downdraft systems allow cooking smoke to drift throughout the kitchen, and into adjoining rooms, where it settles on furniture, fabric, windows, coats walls, and turns into flammable grease. The kitchen has the greatest amount of flammable grease build-up, and with most kitchen fires, grease is accidently ignited to cause a fire. Ignited grease is the number one cause of kitchen fires in the U.S., creating millions of fires, thousands of injuries, and hundreds of deaths each year. Sprinkler systems, fire extinguishers, fire alarms, fire trucks, and all fire related products have one thing in common. They are reactive solutions, and come into play after a cooking fire has started. The current invention is preventative and designed to keep fires from occurring, using two different solutions. The first solution protects against flash cooking oil fires that may take place inside the pan. When these fires flare-up to reach great height, they can set fire to kitchen hardware. Covering the entire pan with the lid suppresses this type of fire from ever occurring.

The second solution to limit kitchen cooking fires is by preventing grease build-up on cabinets, countertops, appliances, walls. and all furniture and fabric. This is achieved by the lid directing all cooking smoke into an area above the stovetop where a range hood or downdraft system captures and exhausts it from the home. In a broad sense, with consistent use of the lid, flammable grease will not build-up on furniture and appliances, and therefore, will prevent many kitchen fires, lower the number of fire related injuries, and reduce the number of kitchen fire deaths in the U.S.

The current invention embodies self-basting of food, which allows food to remain moist both during and after it is cooked. To achieve self-basting, two events need to occur inside the pan. The first is to retain an abundance of moisture and fat emitted from food, and to retain the cooking oil placed inside the pan. When heated, moisture and cooking oil vertically splatters against the non-porous lid underside and drips down onto food. Moisture and oil retention is attained, in part, by the embodiment of a front and rear lip (FIG. 2) located on the lid underside, where it is placed near the front and rear lid openings. This helps lock-in and retain all liquids inside the pan. Self-basting requires an abundance of these liquids to remain inside the pan in order that they splatter vertically against the lid underside. Without this abundance of liquid, self-basting will not be achieved.

The second event that needs to occur inside the pan to achieve self-basting is for cooking smoke to be emitted from the pan in a horizontal direction, and not vertically, which is the direction smoke prefers to move. Forcing cooking smoke to move horizontally is crucial, since self-basting only occurs when moisture and cooking oil vertically splatter against the non-porous lid underside and drips down onto food. Cooking smoke, if allowed to vertically exit the pan, through an opening, or a perforation in the lid, also allows moisture and cooking oil to escape through the same opening, and self-basting, as described in this current invention, will not be possible. Therefore, self-basting is achieved in this current invention by retaining an abundance of moisture and cooking oil inside the pan that vertically splatters against the non-porous lid underside, and secondly, by forcing cooking smoke to exit the pan in a horizontal direction.

The current invention embodies temperature and moisture regulation inside the pan during the cooking process. Temperature regulation, the first embodiment, is described in this paragraph, and in the following paragraph along with the embodiment of moisture regulation. Temperature regulation, for this embodiment, means attaining a certain level of heat inside the pan during the cooking process, and to maintain that level of heat during the complete cooking process. This is achieved by use of the front and rear lip on the lid underside, where they contribute in the retention of heat inside the pan. This heat, regulated by the lid, is approximately thirty degrees higher than if cooking food without a lid. The benefit of this increased pan temperature is the reduction of stovetop energy needed to cook food, and where the stovetop temperature dial, or knob, never needs to be set higher than medium heat to achieve good cooking results. The reduction of energy use also produces cost savings, fewer harmful chemical emissions, and improved indoor air quality for both humans and animals.

The second embodiment of the current invention solves the food searing problem, caused by excessive moisture in the pan once a lid is placed on it. Meat and fish are typically cooked without a lid. However, under-performing exhaust systems require the current invention to direct cooking smoke out of the home, and the lid, therefore, may be the source of excessive moisture that prevents food from searing properly. This problem is resolved by the embodiment of a cutaway, or opening, on the rear of the lid (FIG. 1b). Fresh air is pulled into the pan by the draw, draft, suction, or vacuum, created from cooking smoke as it exits out the front side of the pan. The embodiment of the cutaway, and its dimensions, have been calculated to allow a precise amount of air flow into and through the pan. Cooking smoke inside the pan, for clarification, is forced to follow the upward inclining direction to the front of the lid, where it is emitted from the pan. Fresh air enters the rear opening and flows under the lid and across the pan, a form of heat and moisture regulation, and is then emitted out the front of the pan. The embodiment of the cutaway, its precise dimensions, controls the amount of air flow, or velocity, and allows for three activities to occur inside the pan. The flow of air regulates the proper temperature, when the stovetop is set to medium heat, and the flow of air also helps control overheating inside the pan. The cutaway and air flow solve the moisture and searing problem by preventing excessive amounts of moisture to remain inside the pan. Air flow drawn into the rear of the pan captures a portion of moisture and emit it out the opening at the front of the pan. This moisture extraction allows food, primarily meat and fish, to be cooked crispier, perfectly seared on its outside, while maintaining the perfect amount of moisture on its inside.

In another embodiment of the current invention, the lid may be constructed without front and rear lips on its underside. This embodiment may alter the precise regulation of temperature and moisture inside the pan to degrees that differ from the original embodiment. Nevertheless, the altered construction will not limit or preclude the ability of the lid to retain and extract heat and moisture, nor its ability to sear and moisten food. Furthermore, this current embodiment will not alter or nullify any other embodiment listed in previous and forthcoming paragraphs written herein.

In another embodiment of the current invention, the lid may be constructed with a larger or smaller cutaway dimension, or without the cutaway, or opening, located on the rear of the lid. This embodiment may alter the precise regulation of temperature and moisture inside the pan to degrees that differ from the original embodiment. Nevertheless, the altered construction will not limit or preclude the ability of the lid to retain and extract heat and moisture, nor its ability to sear and moisten food. Furthermore, this current embodiment will not alter or nullify any other embodiment listed in previous and forthcoming paragraphs written herein.

The current invention, when cooking on a stovetop, lowers the volume of pollutants and harmful chemicals (substances) generated inside the pan and emitted from the burner, and therefore, fewer of these substances are released into the outdoor atmosphere. This is achieved as a result of the lid shape and dimensions, that the lid covers and seals the perimeter of the pan, except for the front and rear openings, by the two lips located on the lid underside (FIG. 2), and by air flow entering through the rear of the lid as cooking smoke, and some heat, is emitted out the front of the lid. The embodiment of this construction increases and maintains heat temperature inside the pan approximately thirty degrees higher than cooking without a lid. A number of events occur as a result of maintaining this increased temperature (heat) inside the pan. The first is a reduction of heat generation required by the stovetop, to where the temperature does not require a setting higher than medium heat, and this use of less energy results in a cost savings to the homeowner. Secondly, the lower stovetop energy and temperature requirement, accomplished by the current invention's ability to retain a consistent pan temperature, results in lower amounts of pollutants and harmful chemicals generated inside the pan and emitted from the burner, and subsequently, fewer of these substances need to be captured by the exhaust system, leading to fewer substances being released into the outdoor atmosphere.

The current invention allows the lid to operate in a highly effective splatter-guard manner. Most splatter-guards are constructed by use of a mesh screen supported by a metal frame and handle. The screen is perforated, and unable to contain all cooking oil, moisture, and fat, from being emitted from the pan. The current invention, though, is one solid piece of non-porous material that will not allow moisture, oil, and fat, to escape the pan. The two lips on the underside of the lid (FIG. 2 a and b), located near the front and rear openings, serve as another embodiment to retain moisture, oil, and fat, from escaping the pan.

The current invention improves the quality-of-air within the home in multiple ways. The first is by directing cooking smoke into the exhaust system. Secondly, by preventing cooking smoke from drifting through the home and landing on furniture, fabric, walls, and windows, where cooking smoke converts to grease, and grease has a unique and unpleasant odor that is prevented from occurring in the home. Third, by directing volatile organic compounds (VOCs), fine particulate matter (PM), and their byproducts, into the exhaust system, and preventing these harmful chemicals from being released into the indoor home atmosphere, which results in protecting humans and animals from breathing these chemicals into their lungs.

Therefore, the foregoing is considered as illustrative only of the principles of the invention and embodiments. Further, since numerous modifications and changes will readily occur to those skilled in the art, it is not desired to limit the current invention to the exact construction and operations shown and described. And accordingly, all suitable modifications and equivalents may be resorted to, falling within the scope of the invention, even if modifications are a segment of the total embodiments that make up this current invention.

The invention claimed is:

1. A lid configured for use on top of a pan to direct all cooking smoke, fumes, vapors, harmful toxins, and chemicals, into an overhead range hood or a downdraft exhaust system, and includes:
a) a lid designed to augment under-performing exhaust systems that are unable to capture all cooking smoke, fumes, vapors, and harmful chemicals.
b) a lid designed to work in conjunction with both perfectly operating and under-performing exhaust systems, where these systems may utilize lid embodiments such as harmful chemical exhaustion, fire protection, temperature and moisture control, splatter-guard, and self-basting.

2. A lid to remove fine particulate matter (PM) before it is released into the indoor home atmosphere:
a) by creating or forming a concavity, channel, track, or lip edge, along the perimeter of the lid that extends beyond the perimeter of the pan, in order to capture PM and other harmful chemicals emitted from the stovetop burner.
b) In order to guide captured PM and other harmful chemicals to an area outside the perimeter of the lid and pan, and where the exhaust system can capture them, the lid will incline upward, starting at the rear, its lowest inclined point, and gradually incline upward to a place near the front of the lid, the highest inclined point.
c) and at this point PM and other harmful chemicals are directed into an area where the range hood or downdraft system captures and exhausts them from the home.
d) before humans and animals breathe these chemicals into their lungs.
e) other explanations of this claim, if needed are n [0038 and [0039].

3. A lid, to direct volatile organic compounds (VOCs) into an area outside the perimeter of the front of the lid where a range hood or downdraft system captures VOCs and exhausts them from the home before humans and animals can breathe these chemicals into their lungs.

4. A lid to prevent cooking oil fires from occurring inside a pan, and prevent flammable grease fires by:
a) placing a non-porous cover (the lid) on top of the pan to restrict a flash oil fire from occurring inside a pan.
b) preventing cooking smoke and flammable grease (matter) from landing on cabinets, countertops, walls, appliances, and other furniture, by directing all this matter to an area above the stovetop where it is captured by the exhaust system, and with consistent use of the lid while cooking, it will prevent flammable grease build-up on hardware matter, prevent accidental ignition of this grease, reduce the number of kitchen fires caused by grease build-up, lessen kitchen related injuries, and eliminate many kitchen cooking deaths.
c) a preventative solution to keep kitchen fires from occurring by use of the lid, as opposed to a reactive solution, such as, calling the fire department, or using a fire extinguisher after a fire has started.

5. A lid that self-bastes food, achieved by:
a) retaining large amounts of food moisture, fat, and cooking oil (liquids) inside the pan, in part, by use of a front and rear lip on the lid underside, as one means of retention, and so these liquids, when heated, splatter vertically against the non-porous lid underside and drip down onto the food.
b) retaining large amounts of moisture, fat, and cooking oil inside the pan, in part, by sealing the perimeter of the pan with the lid, except for the front and rear opening,
c) forcing cooking smoke to follow the contour of the lid, and to exit the pan in a horizontal direction, rather than a vertical direction, so liquids inside the pan are allowed to splatter vertically against the non-porous lid underside and to self-baste when this liquid drips down onto food.

6. A lid that embodies temperature control inside the pan approximately thirty degrees higher than cooking food without a lid on the pan. With benefits of:
a) the reduction of stovetop energy needed to cook food.
b) the stovetop temperature dial, or knob, never needs to be set higher than medium heat to achieve excellent cooking results.
c) the reduction of energy use produces cost savings to homeowner.
d) the reduction of energy required by the stovetop results in fewer pollutants and harmful chemical emissions generated from both inside the pan and from the burner, and therefore, less of these substances are captured by the exhaust system and released into the outdoor atmosphere.
e) improved indoor air quality for both humans and animals.
f) other explanations of this claim, if needed, are n [0046, 0047 and 0048].

7. A lid that embodies temperature and moisture control inside the pan by:
a) a solution to the problem of placing a lid on a pan and creating an environment where there is too much heat and too much moisture inside the pan, and where searing food becomes difficult, along with the problem of food containing too much moisture.
b) temperature and moistness control, in part, is achieved by the embodiment of a cutout, or an additional opening at the rear of the lid, having precise dimensions to allow the correct amount of air-flow to enter the pan, and induced by the vacuum created from cooking smoke exiting the pan, and as this air flows through the pan and also exists out the front of the pan, it removes with it excess temperature and moisture from inside the pan.
c) stabilizing the temperature range inside the pan prevents overheating, allowing food to properly sear, and without removing too much moisture from the food.
d) expelling moisture levels that exceeds a normal moisture amount by the embodiment of an opening at the rear of the lid to allow fresh air to be drawn into the pan, induced by the vacuum of cooking smoke being emitted out the front of the pan.
e) stabilizing the moisture level range inside the pan allows food to properly sear, keeps food from becoming overly moist where it loses its texture, and from becoming less appetizing to eat.
e) other explanations of this claim, if needed, are in [0046 and [0047].

8. A lid that improves indoor quality-of-air by:
a) directing all cooking smoke, odor, and harmful chemicals, such as particulate matter and volatile organic compounds into an area outside the front of the lid where a range hood or downdraft system will exhaust all this matter.
b) preventing the dispersion of cooking smoke throughout the home, where it settles on furnishings to create odor.
c) protecting humans and animals from breathing cooking smoke and harmful chemicals into their lungs.

9. A lid used as a splatter-guard while cooking, made from a non-porous material and placed on top of a pan,
a) a lip extends downward on the front and rear underside of the lid, and is placed near the front and rear opening on the lid, to serve as additional embodiments of the splatter-guard to contain all splatter from exiting the pan through front and rear lid openings.

10. A lid of precise design that embodies multiple features, functions, health benefits, and solutions, as listed and described in the forgoing paragraphs, and combining all embodiments into one uniform product without the use of attachments, moving parts, electronic, or dependence on anything outside its form and construction to perform at a high level.
